(19) United States
(12) Patent Application Publication
(10) Pub. No.: US 2008/0295145 A1
(43) Pub. Date: Nov. 27, 2008

(54) IDENTIFYING NON-ORTHOGONAL ROLES IN A ROLE BASED ACCESS CONTROL SYSTEM

(75) Inventors: Bashir A. Haswarey, Arlington Heights, IL (US); Sanjeev A. Joshi, Wauconda, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/752,315

(22) Filed: May 23, 2007

(51) Int. Cl. G06F 17/00

(52) U.S. Cl. 726/1

(57) ABSTRACT

A method for identifying non-orthogonal roles (112, 114, 116, 118) in an access control system (100). The method can include, for at least one policy (P_{n,i}) defined for a first role (112) in the access control system, automatically determining whether there is at least one policy (P_{m,j}) defined in a second role that conflicts with the policy defined in the first role. The method also can include, responsive to determining that the policy defined in the second role conflicts with the policy defined in the first role, providing a conflict indicator.

### BACKGROUND OF THE INVENTION

1. Field of the Invention

The present invention generally relates to role based access control systems.

2. Background of the Invention

Access control systems are commonly implemented to prevent unauthorized access to various types of resources, for instance information systems, applications, processes, managed objects, and the like. Many access control systems are role based; that is, roles may be assigned to users or user groups, and access to protected resources may be based on the assigned roles. For example, users identified as members of human resources may be provided access to create, change and delete confidential personnel records, while users identified as members of management may be granted access only to view such records.

Oftentimes a user may be assigned more than one role. For instance, a user may be assigned a first role as a manager and a second role as a human resources member. Access rules assigned to these different roles may conflict, however, and interfere with proper system operation. For example, even though the user is a member of human resources, based on the user's management role, the user may be denied access to modify personnel records. In a worse scenario, the user may be initially granted access to change records based on the human resources role but, before the changes are complete, denied access based on the management role. Such conflict can interrupt processing of the record changes, and sometimes result in data being corrupted.

### SUMMARY OF THE INVENTION

The present invention relates to a method for identifying non-orthogonal roles in an access control system. The method can include, for at least one policy defined for a first role in the access control system, automatically determining whether there is at least one policy defined in a second role that conflicts with the policy defined in the first role. The method also can include, responsive to determining that the policy defined in the second role conflicts with the policy defined in the first role, providing a first conflict indicator.

In another arrangement, the method can include comparing each policy defined in a first role with each policy defined in a second role to determine whether there is at least one policy defined in the second role that conflicts with at least one of the policies defined in the first role. The method also can include, responsive to determining that at least one policy defined in the second role conflicts with at least one policy defined in the first role, providing a first conflict indicator.

The present invention also can be embedded in a program storage device readable by a machine, tangibly embodying a program of instructions executable by the machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a block diagram of an access control system that is useful for understanding the present invention;

FIG. 2 is a flowchart that is useful for understanding the present invention;

FIG. 3 depicts an output table that is useful for understanding the present invention; and

FIG. 4 depicts an output listing that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method for identifying non-orthogonal roles in an access control system. As used herein, non-orthogonal roles are roles which, with respect to each other, include at least one policy conflict. For example, a first role may include a policy that denies access to a particular resource, while a second role may include a policy that grants access to that resource. Such policies are conflicting, and thus the respective roles in which they are defined are non-orthogonal. Conflicting policies may be policies that are each directed at a particular resource(s) or policies that otherwise affect access to the resource(s). For example, if a first policy denies access to a first resource and a second policy grants access to a second resource that, in a permissions hierarchy, is a child of the first resource, the first and second policies may be considered to be in conflict.

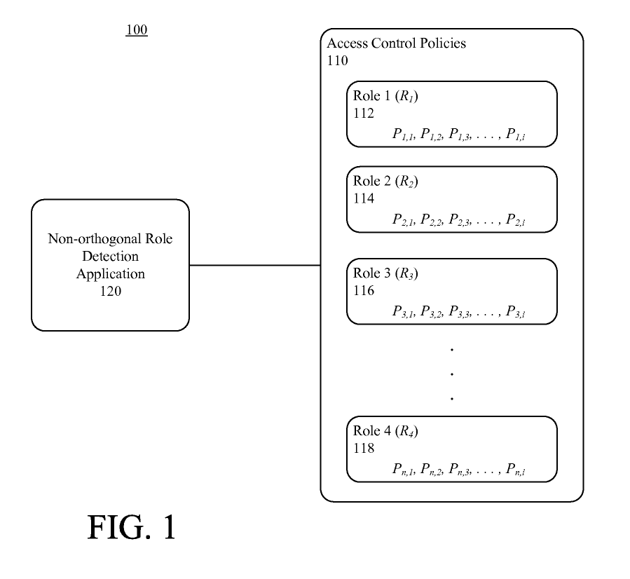

FIG. 1 depicts a block diagram of an access control system 100 that is useful for understanding the present invention. The system 100 can include access control policies 110 defined in roles 112, 114, 116, 118. Each of the respective roles 112-118 may define one or more policies that may be applied to one or more users or user groups to which the roles 112-118 are assigned. For example, the role 112 can define policies P_{1,1} through P_{1,i}, the role 114 can define policies P_{2,1} through P_{2,i}, and so on. A role may define a policy by indicating a protected resource and indicating one or more actions that may be performed (and/or one or more actions that may not be performed) on the indicated resource.

In one arrangement, the protected resources can be information resources, such as information systems, applications, processes, managed objects, and the like. In another arrangement, the resources can be objects, locations, or any other resources that may be secured. The policies can be any policies that may be suitably implemented for the protected resources. For example, if the protected resources are information resources, the policies can grant or deny access to the resources. Such access can include, but is not limited to, actions such as viewing, uploading, downloading, moving or copying the resources. Other examples of suitable actions can include creating, deleting, updating, appending, truncating or otherwise modifying the resources. If the protected resources are objects or locations, the policies can grant or deny access to the resources, specify precautions (e.g. required passwords, escorts, etc.) that may be required when the resources are being accessed, and so on. Still, a myriad of other policies may be defined and the invention is not limited in this regard.

The system 100 also can include a non-orthogonal role detection application 120 which may be used to identify roles 112-118 that are non-orthogonal with respect to one another. To identify non-orthogonal roles, the non-orthogonal role detection application 120 can compare the policies defined within each of the roles 112-118 to policies defined by each of the other roles. For example, the non-orthogonal role detection application 120 can compare the policies defined in the role 112 to the policies defined in the role 114, the policies defined in the role 116, and the policies defined in role 118. Any of the roles 114-118 having one or more policies which conflict with the policies of role 112 can be identified as being non-orthogonal to the role 112. Similarly, the role 112 can be identified as being non-orthogonal to any such roles 114-118 having conflicting policies.

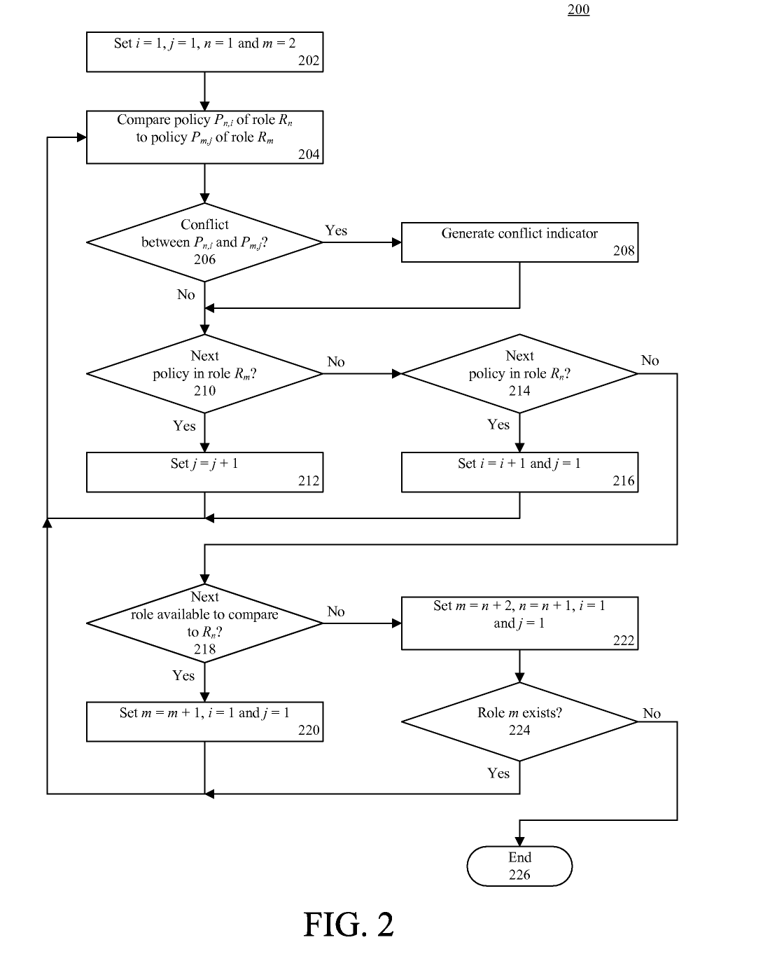

FIG. 2 is a flowchart presenting a method 200 that may be implemented by the non-orthogonal role detection application 120 to identify non-orthogonal roles. The method 200 can begin in a state in which a plurality of roles to be compared have been identified and the process of identifying which roles are non-orthogonal to one another has been initiated. Beginning at step 202, variables i,j and n can be set to 1 and a variable m can be set to 2. At step 204, a policy P_{n,i} of role Rₙ can be compared to a policy P_{m,j} of role Rₘ. Based on the variables previously set, at this point the policy P_{n,i} can be the first policy (P_{1,1}) of a first role (R₁) and the policy P_{m,j} can be the first policy P_{2,1} of a second role (R₂).

Referring to decision box 206, a determination can be made whether there is a conflict between the policy P_{n,i} and the policy P_{m,j}. The policies P_{n,i} and P_{m,j} may conflict, for example, if they both are directed to the same resource, but they provide different access rights. For example, the policy P_{n,i} may deny access to the resource while the policy P_{m,j} grants access to the resource. If there is a conflict between the P_{n,i} and the policy P_{m,j}, the process can proceed to step 208 and a conflict indicator can be generated. The conflict indicator can indicate that there is a conflict between the policies P_{n,i} and P_{m,j} and/or that there is a conflict between the roles Rₙ and Rₘ. The conflict indicator can be stored to a computer usable medium and/or presented to a user.

In an arrangement in which it is desired to identify only which roles are non-orthogonal to one another and it is not required to identify specific policies that conflict, the process can proceed from step 208 to step 218 without performing steps 210-216. That is, since a conflict between roles Rₙ and Rₘ has already been identified, it may not be necessary to continue comparing policies in the presently selected roles, and the process can proceed immediately to selecting a new role for comparison to role Rₙ. Alternatively, if it is desired to identify specific policies that are conflicting, for instance for trouble shooting purposes, the process can proceed from step 208 to decision box 210. The process also can proceed from decision box 206 to decision box 210 if there was no conflict detected between the policies P_{n,i} and P_{m,j}.

At decision box 210, a determination can be made whether there is a next policy in role Rₘ. If so, at step 212 the variable j can be incremented by one in order to select the next policy P_{m,j} (e.g. P_{2,2}) in role Rₘ for comparison to the presently selected policy P_{n,i} of role Rₙ at step 204. If, however, there are no further policies in role Rₘ which have not been compared to the presently selected policy P_{n,i} of role Rₙ, the process can proceed to decision box 214.

At decision box 214, a determination can be made whether there are additional policies P_{n,i} in role Rₙ for comparison to the policies in role Rₘ. If there is one or more additional polices in role Rₙ, the process can proceed to step 216 and the variable i can be incremented by 1, whereas the variable j can be set to 1. For example, if the first policy P_{1,1} of the first role of R₁ has been compared to each of the policies of the second role R₂, the variable i can be incremented to 2 to select the second policy P_{1,2} of role R₁ for comparison to the policies of role R₂. Setting the variable j to 1 can result in the first policy P_{2,1} of role R₂ being selected to begin the comparison process against the policy P_{1,2}. The process can again proceed to step 204 for the comparison to be made.

If at decision box 214 a determination is made that there are no further policies in role Rₙ, remaining to be compared to the presently selected role Rₘ, the process can proceed to decision box 218 and a determination can be made whether there are additional roles available to compare to role Rₙ. If there are additional roles, at step 220 the variable m can be incremented by 1, and the variables i and j can be set to 1. Thus, a next role Rₘ (e.g. role R₃) can be selected, and the first policies (e.g. P_{1,1} and P_{3,1}) in the respective roles Rₙ and Rₘ can be selected for comparison at step 204.

If at decision box 218 there are no additional roles to be compared to role Rₙ, the process can proceed to step 222. The variable m can be set to be equal to n+2 and the variable n can be incremented by 1. For example, if the current role Rₙ is role 1, role 2 can be selected as the role Rₙ and role 3 can be selected as the role Rₘ. Similarly, if the current role Rₙ is role 4, role 5 can be selected as the role Rₙ and role 6 can be selected as the role Rₘ. At decision box 224, if the new role Rₘ exists, the process can proceed back to step 204 and the process of comparing the newly selected roles can begin in order to determine whether they are non-orthogonal.

By way of example, if there are 6 roles and the policies of role R₁ have already been compared to the policies of roles R₂ through R₆, at step 222 role R₂ can be selected so that its policies can be compared to roles R₃ through R₆. Continuing with the example, once the policies of role R₂ have been compared to roles R₃ through R₆, the policies of role R₃ can be compared to roles R₄ through R₆, and so on.

Referring again to decision box 224, if the new role does not exist (e.g. role 7 has been selected for role Rₘ, but there are only 6 roles available), the process can end at step 226.

The examples discussed herein have been presented with a small number of roles and policies for the purpose of clarity. Notwithstanding, the invention is not limited in this regard. One skilled in the art will appreciate that any number of roles can be compared and each of the roles may comprise any number of policies. Indeed, it is anticipated that some systems may include hundreds, thousands or millions of defined roles, and roles may include hundreds, thousands or millions of defined policies.

It also should be noted that the present invention is not limited to comparing the roles and/or policies in any particular order. For example, rather than incrementing the variables i,j,n and m to proceed through the comparison process, one skilled in the art will appreciate that one or more of the variables can be decremented or processed in any other suitable manner.

Further, the flowchart and block diagram in the figures illustrate the architecture, functionality, and operation of possible implementations of systems, methods and computer program products according to various embodiments of the present invention. In this regard, each step or decision box in the flowchart or block in the block diagram may represent a module, segment, or portion of code, which comprises one or more executable instructions for implementing the specified logical functions. It should also be noted that, in some alternative implementations, the functions noted in the steps and/or decision boxes may occur out of the order noted in the figures. For example, two steps and/or decision boxes shown in succession may, in fact, be executed substantially concurrently, or the steps and/or decision boxes may sometimes be executed in the reverse order, depending upon the functionality involved.

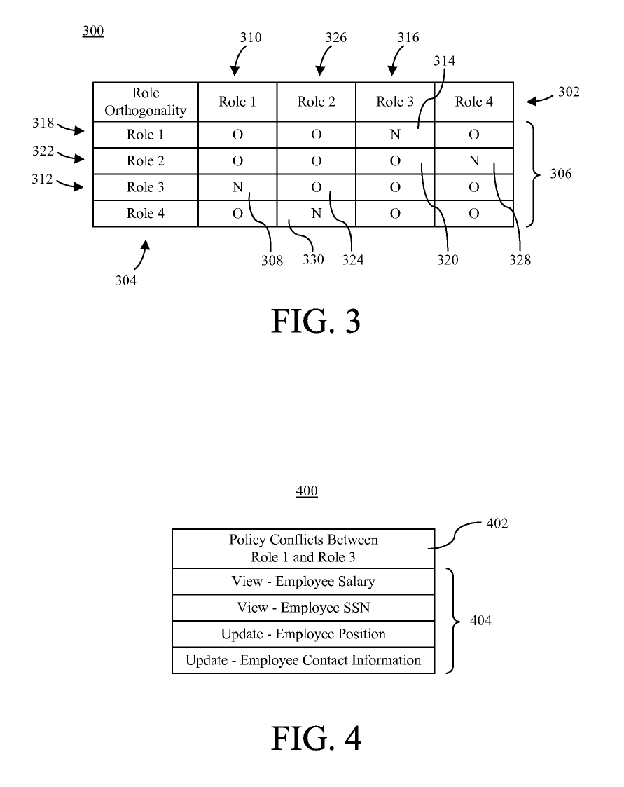

FIG. 3 depicts an output table 300 that is useful for understanding the present invention. The output table 300 may be displayed on a screen, printed, or presented in any other suitable manner. The output table 300 can include a plurality of column headers 302, a plurality of row headers 304, and a plurality of cells 306 at the intersections of the column headers 302 and row headers 304. The column and row headers 302, 304 can identify specific roles which may have been compared to one another, and the cells 306 can indicate which roles are orthogonal or non-orthogonal to one another. Such indication can be based on the conflict indicator generated by the process previously described in the method 200.

For example, if role 1 was determined to be non-orthogonal to role 3, a cell 308 at the intersection of column 310 and row 312 can indicate such determination. For instance, one or more alphanumeric characters, a pattern, or a particular color can be presented in the cell 308, or such indication can be presented in any other suitable manner. Similarly, a cell 314 at the intersection of column 316 and row 318 also can indicate that role 1 and role 3 are non-orthogonal. Thus, if a user is interested in identifying roles that are non-orthogonal to a particular role, such as role 1, the user can have the option of perusing the column 310 or perusing a row 318. Alternatively, one of the cells 308, 314 can be blank or provided with another indicator.

In another example, if role 2 was determined to be orthogonal to role 3, a cell 320 at the intersection of column 316 and row 322 can indicate such determination. As noted, such determination can be indicated with one or more alphanumeric characters, a pattern, a color, or presented in any other suitable manner. Similarly, a cell 324 at the intersection of a column 326 and row 312 also can indicate that role 2 and role 3 are orthogonal.

In addition to, or in lieu of, indicating which roles are orthogonal and non-orthogonal to one another, policies which are in conflict with one another can be indicated. For example, referring to FIG. 4, an output listing 400 can be presented to indicate which policies conflict for selected roles. The output listing 400 can include a header 402 that indicates the selected roles and rows (or columns) 404 that indicate the identified conflicts. For instance, assume that Role 1 provides access to view and manipulate (e.g. add, update, delete, etc.) employee records, including employee salary, social security number (SSN), position and contact information. Also assume that Role 3 prohibits viewing employee salary and SSN information, and that Role 3 prohibits updating employee position information and contact information. The rows (or columns) 404 can indicate one or more of the policies that are in conflict. For example, the rows 404 can indicate subject resources (e.g. employee salary, employee SSN, employee position and employee contact information), as well as actions to be performed on the resources that are in conflict (e.g. view and update).

In one arrangement, the output listing 400 can be presented in response to a user selecting a corresponding cell in the table 300 in FIG. 3. For example, in response to a user selecting the cell 308 or the cell 314 of table 300, the output listing 400 that is presented can include the policies in Roles 1 and 3 that are conflicting. Similarly, in response to a user selecting a cell 328 or the cell 330 of table 300, the output listing 400 that is presented can include the policies in Roles 2 and 4 that are conflicting. The cells 308, 314, 328, 330 that are selected to present the output listing 400 can be selected using a curser, a stylus, an alphanumeric input, a voice input or in any other suitable manner. For example, in an arrangement in which the table 300 is presented in a graphical user interface, a user can select a desired cell using a stylus or curser.

As will be appreciated by one skilled in the art, the present invention may be embodied as a method, system, or computer program product. Accordingly, the present invention may take the form of an entirely hardware embodiment, an entirely software embodiment, including firmware, resident software, micro-code, etc., or an embodiment combining software and hardware aspects.

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. The medium can be, for example, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for identifying non-orthogonal roles in an access control system, comprising:
for at least one policy defined for a first role in the access control system, automatically determining whether there is at least one policy defined in a second role that conflicts with the policy defined in the first role; and
responsive to determining that the policy defined in the second role conflicts with the policy defined in the first role, providing a first conflict indicator.

2. The method of claim 1, wherein determining whether there is at least one policy defined in the second role that conflicts with the policy defined in the first role comprises comparing each policy defined in the first role with each policy defined in the second role.

3. The method of claim 1, wherein determining whether there is at least one policy defined in the second role that conflicts with the policy defined in the first role comprises:
selecting a first policy defined in the first role;
sequentially comparing each policy defined in the second role to the first policy;
selecting at least a second policy defined in the first role; and
sequentially comparing each policy defined in the second role to the second policy.

4. The method of claim 1, further comprising:
for at least one policy defined for the first role in the access control system, automatically determining whether there is at least one policy defined in a third role that conflicts with the policy defined in the first role; and
responsive to determining that the policy defined in the third role conflicts with the policy defined in the first role, providing a second conflict indicator.

5. The method of claim 1, further comprising:
for at least one policy defined for the second role in the access control system, automatically determining whether there is at least one policy defined in a third role that conflicts with the policy of the second role; and
responsive to determining that the policy defined in the third role conflicts with the policy defined in the second role, providing a second conflict indicator.

6. The method of claim 1, wherein determining whether there is at least one policy defined in the second role that conflicts with the policy defined in the first role comprises:
identifying at least one policy defined in the second role that is directed to a same resource as the policy defined in the first role; and
determining that the identified policy provides access rights to the resource that are different than access rights provided by the policy defined in the first role.

7. The method of claim 1, further comprising presenting the first conflict indicator.

8. The method of claim 7, further comprising:
responsive to receiving a user section of the first conflict indicator, presenting an output listing that lists policies in the second role that conflict with policies in the first role.

9. A method for identifying non-orthogonal roles in an access control system, comprising:
comparing each policy defined in a first role with each policy defined in a second role to determine whether there is at least one policy defined in the second role that conflicts with at least one of the policies defined in the first role; and
responsive to determining that at least one policy defined in the second role conflicts with at least one policy defined in the first role, providing a first conflict indicator.

10. The method of claim 9, further comprising:
comparing each policy defined in a third role with each policy defined in the second role to determine whether there is at least one policy defined in the third role that conflicts with at least one of the policies defined in the second role; and
responsive to determining that at least one policy defined in the third role conflicts with at least one policy defined in the second role, providing a second conflict indicator.

11. The method of claim 10, further comprising presenting the first and second conflict indicators.

12. The method of claim 11, further comprising:
responsive to receiving a user section of the first conflict indicator, presenting an output listing that lists policies in the second role that conflict with policies in the first role; and
responsive to receiving a user section of the second conflict indicator, presenting an output listing that lists policies in the third role that conflict with policies in the second role.

13. A program storage device readable by a machine, tangibly embodying a program of instructions executable by the machine to perform method steps for identifying non-orthogonal roles in an access control system, said method steps comprising:
for at least one policy defined for a first role in the access control system, automatically determining whether there is at least one policy defined in a second role that conflicts with the policy defined in the first role; and
responsive to determining that the policy defined in the second role conflicts with the policy defined in the first role, providing a first conflict indicator.

14. The program storage device of claim 13, wherein determining whether there is at least one policy defined in the second role that conflicts with the policy defined in the first role comprises comparing each policy defined in the first role with each policy defined in the second role.

15. The program storage device of claim 13, wherein determining whether there is at least one policy defined in the second role that conflicts with the policy defined in the first role comprises:
selecting a first policy defined in the first role;
sequentially comparing each policy defined in the second role to the first policy;
selecting at least a second policy defined in the first role; and
sequentially comparing each policy defined in the second role to the second policy.

16. The program storage device of claim 13, said method steps further comprising:
for at least one policy defined for the first role in the access control system, automatically determining whether there is at least one policy defined in a third role that conflicts with the policy defined in the first role; and
responsive to determining that the policy defined in the third role conflicts with the policy defined in the first role, providing a second conflict indicator.

17. The program storage device of claim 13, said method steps further comprising:
for at least one policy defined for the second role in the access control system, automatically determining whether there is at least one policy defined in a third role that conflicts with the policy of the second role; and
responsive to determining that the policy defined in the third role conflicts with the policy defined in the second role, providing a second conflict indicator.

18. The program storage device of claim 13, wherein determining whether there is at least one policy defined in the second role that conflicts with the policy defined in the first role comprises:
identifying at least one policy defined in the second role that is directed to a same resource as the policy defined in the first role; and
determining that the identified policy provides access rights to the resource that are different than access rights provided by the policy defined in the first role.

19. The program storage device of claim 13, said method steps further comprising presenting the first conflict indicator.

20. The program storage device of claim 19, said method steps further comprising:
responsive to receiving a user section of the first conflict indicator, presenting an output listing that lists policies in the second role that conflict with policies in the first role.
